(19) United States
(12) Patent Application Publication
(10) Pub. No.: US 2021/0366450 A1
(43) Pub. Date: Nov. 25, 2021

(54) INFORMATION PROCESSING APPARATUS, INFORMATION PROCESSING METHOD, AND RECORDING MEDIUM

(71) Applicant: SONY CORPORATION, Tokyo (JP)

(72) Inventors: Kei TAKAHASHI, Tokyo (JP); Junichi SHIMIZU, Tokyo (JP)

(73) Assignee: SONY CORPORATION, Tokyo (JO)

(21) Appl. No.: 17/287,374

(22) PCT Filed: Sep. 5, 2019
(86) PCT No.: PCT/JP2019/034883

§ 371 Date: Apr. 21, 2021

(30) Foreign Application Priority Data
Nov. 1, 2018 (JP) 2018-206671

(51) Int. Cl. G10H 1/00; G10H 1/40

(52) U.S. Cl. CPC G10H 1/0033; G10H 2220/395; G10H 2210/391; G10H 1/40

(57) ABSTRACT

A mechanism that enables the real-time provision of content according to a user's body movement is provided. An information processing apparatus includes a reproduction control unit (43) that controls reproduction of content on the basis of a result of prediction of a timing of a predetermined state in traveling movement of a user, which is predicted on the basis of sensor information regarding the traveling movement.

### TECHNICAL FIELD

The present disclosure relates to an information processing apparatus, an information processing method, and a recording medium.

### BACKGROUND ART

In recent years, technologies to provide content according to the result of detection of a user's body movement have been proposed. As an example, a technology to provide a walker with music content having a tempo corresponding to the walking tempo of the walker has been proposed. Further, Patent Document 1 below discloses a technology to create a music selection list for providing a user with music content having a tempo corresponding to the walking tempo of another walker.

### CITATION LIST

### Patent Document

Patent Document 1: Japanese Patent Application Laid-Open No. 2007-250053

### SUMMARY OF THE INVENTION

### Problems to be Solved by the Invention

In the technology proposed in Patent Document 1 above and others, the result of detection of a user's body movement is used to provide music content. However, an attempt to reproduce content in real time at a timing according to the result of detection of a use body movement causes a time lag between the timing and a timing at which the content is reproduced. This is because various types of processing such as sensing, detection processing on the user's body movement based on sensor information obtained as a result of the sensing, and the reading of the content are performed between the occurrence of the user's body movement and the start of the reproduction of the content.

Therefore, the present disclosure provides a mechanism that enables the real-time provision of content according to a user's body movement.

### Solutions to Problems

According to the present disclosure, an information processing apparatus is provided which includes a reproduction control unit that controls reproduction of content on the basis of a result of prediction of a timing of a predetermined state in traveling movement of a user, which is predicted on the basis of sensor information regarding the traveling movement.

Further, according to the present disclosure, an information processing method performed by a processor is provided which includes controlling reproduction of content on the basis of a result of prediction of a timing of a predetermined state in traveling movement of a user, which is predicted on the basis of sensor information regarding the traveling movement.

Furthermore, according to the present disclosure, a recording medium is provided in which a program is recorded to cause a computer to function as a reproduction control unit that controls reproduction of content on the basis of a result of prediction of a timing of a predetermined state in traveling movement of a user, which is predicted on the basis of sensor information regarding the traveling movement.

### BRIEF DESCRIPTION OF DRAWINGS

FIG. 1 is a diagram for explaining an outline of an information processing apparatus according to one embodiment of the present disclosure.

FIG. 2 is a diagram for explaining a technical problem.

FIG. 3 is a block diagram showing an example of a logical functional configuration of the information processing apparatus according to the present embodiment.

FIG. 4 is a diagram for explaining an example of reproduction control according to the present embodiment.

FIG. 5 is a flowchart showing an example of a flow of a content reproduction control process performed by the information processing apparatus according to the present embodiment.

FIG. 6 is a flowchart showing an example or a flow of a reliability-based reproduction control process performed by the information processing apparatus according to the present embodiment.

FIG. 7 is a block diagram showing another example of a logical configuration of the information processing apparatus according to the present embodiment.

FIG. 8 is a diagram for explaining an example of control of a sound source reproduction parameter according to the present embodiment.

FIG. 9 is a flowchart showing an example of a process of controlling a sound source reproduction parameter according to the present embodiment.

FIG. 10 is a diagram for explaining an example of reproduction system of the sound of footsteps according to the beat of a sound source being reproduced, according to the present embodiment.

FIG. 11 is a diagram for explaining an example of reproduction control according to bars of a multitrack sound source being reproduced, according to the present embodiment.

FIG. 12 is a flowchart showing an example of a flow of a reproduction control process according to bars of a multitrack sound source being reproduced, which is performed by the information processing apparatus according to the present embodiment.

FIG. 13 is a block diagram showing an example of a hardware configuration of the information processing apparatus according to the present embodiment.

### MODE FOR CARRYING OUT THE INVENTION

Hereinafter, a preferred embodiment of the present disclosure will be described is detail with reference to the accompanying drawings. Note that in the present description and the drawings, the same reference numerals are assigned to components having substantially the same functional configurations to avoid redundant explanations.

Note that the description will be made in the following order.

1. Introduction

2. Configuration example

3. Technological features
3.1. Basic processing
3.2. Modifications

4. Hardware configuration example

5. Summary

### 1. INTRODUCTION

### (1) Outline

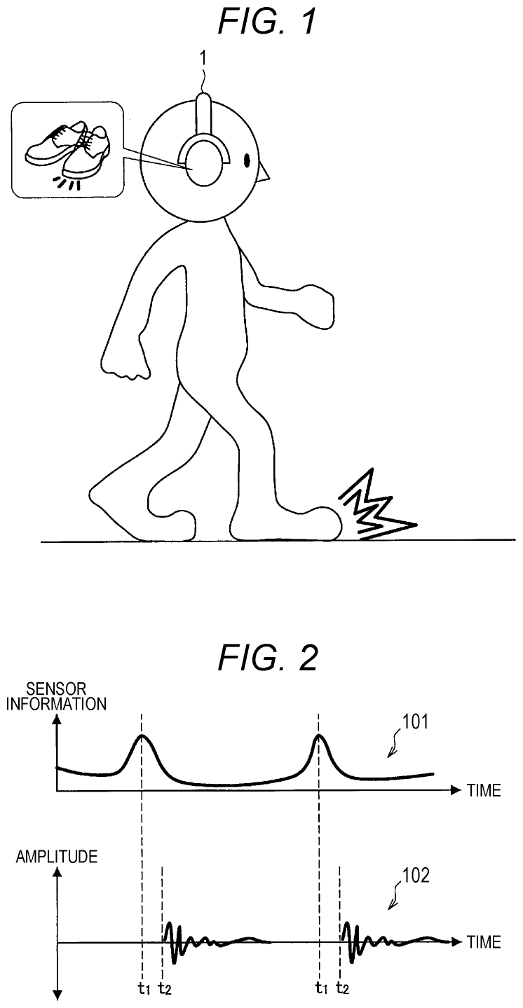

An information processing apparatus according to one embodiment of the present disclosure is an apparatus having a function to control the reproduction of content. The content is data including sounds, images, and/or tactile stimuli, such as sound effects, music, images, a movie, or a game. Hereinafter, an outline of an information processing apparatus according to one embodiment of the present disclosure will be described with reference to FIG. 1.

FIG. 1 is a diagram for explaining an outline of an information processing apparatus 1 according to the present embodiment. The information processing apparatus 1 shown in FIG. 1 is a headphone-type apparatus and can output sounds as content. The information processing apparatus 1 includes sensors such as an acceleration sensor and a gyroscope sensor inside, and can output content on the basis of sensor information obtained by the sensors.

For example, a user wearing the information processing apparatus 1 can perform traveling movement. Here, traveling movement is movement involving landing, such as walking, running, or jumping. At this time, as shown in FIG. 1, the information processing apparatus 1 can detect the timing of the user landing on the basis of the sensor information, and reproduce the sound of a footstep according to the detected timing. However, an attempt to reproduce the sound of a footstep in real time at a timing according to the result of detection of the user's traveling movement causes a time lag between the landing timing and the timing at which the sound of a footstep is reproduced. This is because various types of processing such as sensing, the detection of the landing timing based on the sensor information, and the reading of the sound of a footstep are performed between the occurrence of the user's landing and the start of the reproduction of the sound of a footstep. This point will be described in detail with reference to FIG. 2.

FIG. 2 is a diagram for explaining a technical problem. An upper graph 101 in FIG. 2 is a graph showing the temporal transition level of the sensor information, where the vertical axis is the sensor information (e.g., acceleration), and the horizontal axis is time. A lower graph 102 in FIG. 2 is a graph showing the waveform of the sound of footsteps output at timings according to the results of landing detection based on the sensor information, where the vertical axis is amplitude and the horizontal axis is time. Assume that landing occurs at a peak timing t₁ of the sensor information shown in the graph 101. It is desirable that the sound of a footstep be output at the landing timing t₁. However, since various types of processing are performed between the occurrence of landing and the start of the reproduction of the sound of a footstep, a time lag occurs between the landing timing t₁ and a timing t₂ at which the reproduction of the sound of a footstep is started, as shown in the graph 102.

Therefore, the present disclosure provides a mechanism that enables the real-time provision of content according to a user's body movement.

Specifically, in the proposed technology, the reproduction of content is controlled on the basis of the result of prediction of a user's traveling movement. For example, the information processing apparatus 1 starts the reproduction of content earlier on the basis of the result of prediction of a landing timing. This prevents the occurrence of a time lag describes with reference to FIG. 2, allowing the reproduction of the sound of a footstep at the user's landing timing.

On the other hand, in a case where the user stops, for example, a prediction result may differ from an actual movement. Therefore, in the proposed technology, the detection and prediction of the user's movement are performed in parallel, and the reproduction of content is controlled by a combination of them. For example, while the information processing apparatus starts to reproduce the sound of a footstep at a predicted landing timing, it lowers the volume of the sound of the footstep being reproduced if landing is not detected at the timing. Such processing allows the provision of content that is felt less strange even if a prediction result is different from an actual movement.

Note that the configuration of the information processing apparatus 1 shown in FIG. 1 is merely an example. The information processing apparatus 1 may be implemented as, for example, a smartphone, a tablet terminal, a head-mounted display (HMD), or the like, other than headphones.

### (2) Use Cases

### First Use Case

A first use case is a use case where a user enjoys playing the role of a character. The user wears headphones (corresponding to the information processing apparatus 1) that he or she usually wears or are lent at a theme park or the like. Then, when the user enters a specific area, or an application on a smartphone connected to the headphones is started, the sound of footsteps are output in synchronization with the user's traveling movement. For example, in a case where the character is a robot, the sound of footsteps of a squeaky machine is output. In a case where the character is a small animal, the sound of lightly bouncing footsteps is output. The presentation of the sound of footsteps according to the character in this way allows the user to enjoy playing the role of the character.

### Second Use Case

A second use case is a use case where a user enjoys a virtual space. The user wears an HMD with headphones (corresponding to the information processing apparatus 1). The HMD can provide the user with an augmented reality (AR) experience by a transmissive display device superimposing and displaying a virtual object on a real space. Furthermore, the HMD can provide the user with a virtual reality (VR) experience by a non-transmissive display device displaying a virtual space. For example, when the user walks on an area where water has collected in a virtual space, the HMD outputs the sound of footsteps on water. Thus, by the presentation of the sound of footsteps according to the virtual space, the user can be more immersed in the virtual space.

### 2. CONFIGURATION EXAMPLE

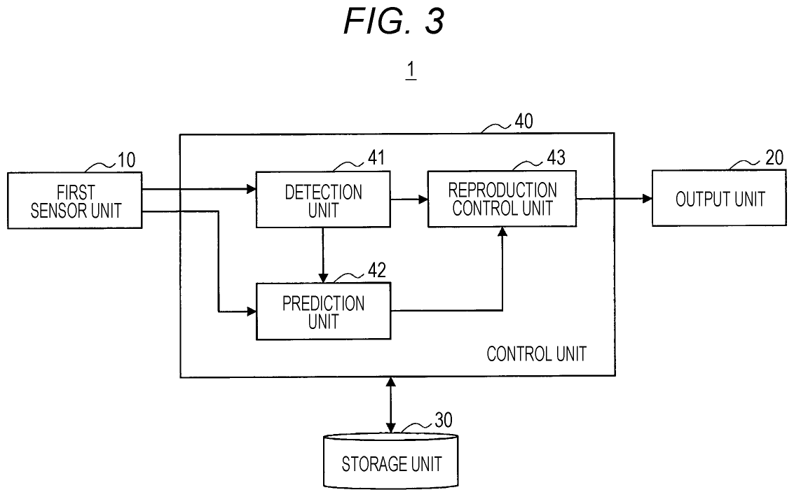

FIG. 3 is a block diagram showing an example of a logical functional configuration of the information processing apparatus 1 according to the present embodiment. As shown in FIG. 3, the information processing apparatus 1 includes a first sensor unit 10, an output unit 20, a storage unit 30, and a control unit 40.

### (1) First Sensor Unit 10

The first sensor unit 10 has a function to sense information regarding the user's traveling movement. In particular, it has a function to sense the user's body movement of the first sensor unit 10. For example, the first sensor unit 10 includes an acceleration sensor and a gyroscope sensor, and senses sensor information indicating an up-and-down motion of the body and an impact at the time of landing, or the like in traveling movement. In addition, the first sensor unit 10 may sense the movement of each part of the user's body, such as the movement of the hands or the movement of the head.

The first sensor unit 10 outputs sensor information obtained as a result of sensing to the control unit 40.

### (2) Output Unit 20

The output unit 20 has a function to output content on the basis of control by the control unit 40. For example, the output unit 20 includes a display device that outputs images, a sound output device that outputs sounds, and/or a tactile stimulus output device that outputs tactile stimuli. The display device is implemented by, for example, a display, a projector, or a retinal projection device. The sound output device is implemented by, for example, headphones, earphones, or headphones. The tactile stimulus output device is implemented by, for example, an eccentric motor, a low-frequency output device, or an electrical stimulus output device.

### (3) Storage Unit 30

The storage unit 30 has a function to store information used in information processing by the information processing apparatus 1. For example, the storage unit 30 stores content to be output from the output unit 20. In addition, the storage unit 30 stores various types of setting information for content reproduction control.

### (4) Control Unit 40

The control unit 40 functions as an arithmetic processing unit and a controller, and has a function to control all operations in the information processing apparatus 1 according to various programs. As shown in FIG. 3, the control unit 40 includes a detection unit 41, a prediction unit 42, and a reproduction control unit 43.

### Detection Unit 41

The detection unit 41 has a function to detect a state in the user's traveling movement, on the basis of sensor information regarding the user's traveling movement. For example, the detection unit 41 detects the timing of a predetermined state in the traveling movement. The timing of the predetermined state is, for example, the timing of landing in walking movement or running movement, or the timing of reaching the highest point in jumping movement. Note that the highest point in jumping movement refers to a state in which the distance between the ground and any part of the body such as the foot, the head, or the center of gravity becomes the largest. Of course, the predetermined state is not limited to these examples, and may include any state in the traveling movement. For example, the detection unit 41 detects the timing of the predetermined state in the traveling movement on the basis of the time-series transition of the sensor information indicating acceleration in the Gravity direction or the like, or the time-series transition of the result of calculation based on the sensor information such as inertial navigation system (INS) calculation. In addition, the detection unit 41 can detect various states such as a stop of the traveling movement and a change in traveling direction. Further, the detection unit 41 can detect the magnitude of the traveling movement (walking, running, or the like) on the basis of the amplitude and/or period of the sensor information or the like. The detection unit 41 outputs information indicating the detection result to the reproduction control unit 43. Note that the sensor information may be raw data obtained from the sensors, or may be the processing result of applying predetermined processing such as averaging or exclusion of outliers to raw data. Further, the timing may refer to a time, the time elapsed from a predetermined time, or the processing result of applying predetermined processing to these values.

### Prediction Unit 42

The prediction unit 42 has a function to predict the timing of the predetermined state in the user's traveling movement on the basis of the sensor information regarding the traveling movement. That is, the prediction unit 42 has a function to predict a timing to be detected by the detection unit 41 before it is detected by the detection unit 41. For example, the prediction unit 42 predicts the timing of the predetermined state in the traveling movement on the basis of the sensor information, the result of calculation based on the sensor information such as INS calculation, and/or the result of detection by the detection unit 41.

### Reproduction Control Unit 43

The reproduction control unit 43 has a function to control the reproduction of content by the output unit 20 on the basis of the result of prediction by the prediction unit 42. For example, the reproduction control unit 43 reproduces content stored in the storage unit 30 with reproduction parameters according to the result of prediction by the prediction unit 42. The reproduction parameters include, for example, identification information of content to be reproduced, reproduction timing, volume, effect, etc. Further, the reproduction control unit 43 may control content on the basis of the result of detection by the detection unit 41. For example, The reproduction control unit 43 reproduces content stored in the storage unit 30 with reproduction parameters according to the result of detection by the detection unit 41 and the result of prediction by the prediction unit 42.

### 3. TECHNOLOGICAL FEATURES

### 3.1. Basic Processing

### (1) Prediction of Timing of Predetermined State

### Prediction Using Time-Series Transition of Detection Result

The timing of the predetermined state may be predicted on the basis of the time-series transition of the time interval between timings of the predetermined state that have been detected on the basis of the sensor information For example, the prediction unit 42 can predict the next landing timing by adding the mean value of the time intervals between past landing timings to the previous landing timing. This is because walking is usually regular motion.

For example, landing intervals D₀, D₁, . . . Tₙ₋₁ are defined as D₀=T₁−T₀, D₁=T₂−T₁, . . . , and Dₙ₋₁=Tₙ−Tₙ₋₁, respectively, where T₀, T₁, T₂, . . . , and Tₙ are past landing times in chronological order. Here, the next landing time Tₙ₊₁ is calculated as Tₙ₊₁=Tₙ+Dₙ, where Tₙ is the current time. Dₙ is, for example, the mean value of D₀ to Dₙ₋₁. In calculating Dₙ, by excluding outliers of D₀ to Dₙ₋₁ or weighting the latest value more, Dₙ can be predicted more accurately.

### Prediction Using Trend in Sensor Information

The timing of the predetermined state may be predicted. on the basis of the time-series transition of the sensor information. For example, the prediction unit 42 predicts the next landing timing on the basis of a trend indicated by the time-series transition of the sensor information.

For example, the vector v of a gravity direction component in walking is known, an acceleration component in the gravity direction can be determined by the inner product of the vector v and the value (x, y, z) of the acceleration sensor. Using the time-series transition of the acceleration component in the gravity direction and the result of detection of the landing timing, the prediction unit 42 learns how many seconds later after the acceleration component in the gravity direction exceeds a predetermined threshold value, landing occurs, to use it for prediction. Note that the timing of landing can be specified as the timing at which the norm √(x\hat{ }2+y\hat{ }2+z\hat{ }2) of the acceleration sensor value that has increased takes a downward turn.

### Prediction Based on Time-Series Transition of Sensor Information or Result of Calculation Based on Sensor Information

The timing of the predetermined state may be predicted on the basis of the result of prediction of the time-series transition of the sensor information or the result of prediction of the time-series transition of the result of calculation based on the sensor information. For example, the prediction unit 42 predicts the time-series transition of the sensor information or the result of calculation based on the sensor information, and predicts the timing of the next landing on the basis of the prediction result. Any model such as a recurrent neural network (RNN) can be used to predict the time-series transition. Further, an object to be predicted may be the sensor information itself, the above-mentioned inner product of the vector in the gravity direction and the value of the acceleration sensor, or the above-mentioned norm.

### Supplement

The prediction techniques described above may be used in combination as appropriate. For example, individual prediction results may be weighted and averaged according to prediction accuracy, to provide a final prediction result.

### (2) Content Reproduction Control

The reproduction control unit 43 reproduces content at a predicted timing of the predetermined state. The reproduction control unit 43 reads the content before the predicted timing of the predetermined state, and starts the reproduction of the content at the timing. Further, the reproduction control unit 43, the reproduction control unit 43 may start the reproduction of sound before the predicted timing at which the predetermined state occurs. For example, the reproduction control unit 43 starts the reproduction of sound ahead of the predicted timing at which the predetermined state occurs by an attack section (a section from the rise of the sound to the maximum volume) so that the maximum volume is reproduced at the predicted timing at which the predetermined state occurs. This allows content according to a predetermined state to be presented at the same timing as the timing at which a user's state becomes the predetermined state. Note that a sound that has risen reaches the maximum volume through an attack section, and then attenuates and disappears. Specifically, a sound includes an attack section, a decay section, a sustain section, and a release section in order in the time direction. The decay section is a section in which the volume attenuates from the maximum volume. The sustain section is a section in which the volume that has attenuated through the decay section lasts. The release section is a section until the volume attenuates and disappears.

The reproduction control unit 43 controls the reproduction of the content when it is not detected from the sensor information that the predetermined state actually occurs at the predicted timing of the predetermined state. Specifically, the reproduction control unit 43 controls the reproduction of the content when the detection unit 41 does not detect that the predetermined state actually occurs at the timing of the predetermined state predicted by the prediction unit 42. Alternatively, the reproduction control unit 43 controls the reproduction of the content when the detection unit 41 detects a trend in which the predetermined state does not occur (for example, a state in which the user is likely to slow down the walking speed and stop walking). As the control of the content reproduction here, the reproduction control unit 43 stops the reproduction of the content, lowers the volume, or applies a predetermined effect to the content reproduced, for example. The predetermined effect is blurring, fade-out, or the like. Blurring applied to a sound refers to controlling the volume so that it does not reach the maximum volume of the sound defined in the content, or controlling the volume within a range in which it does not reach the maximum volume, rather than simply lowering the volume. Specifically, blurring applied to a sound may be the control of the strength of the attack, which will be described later. Blurring applied to a sound may be considered as control to add a spatial expanse to the sound. Specifically, blurring applied to a sound may be a spatial effect such as reverb, delay, or an echo. Blurring applied to an image is control to obscure the outline or boundary of an object seen in image content, such as mosaic processing. Further, fade-out applied to a sound refers to controlling the volume so that the sound gradually disappears without exceeding the maximum volume of the sound defined in the content. Furthermore, fade-out applied to an image refers to controlling the image so that it gradually disappears, such as gradually increasing the transmittance of the image to make it completely transparent. For example, while the reproduction control unit 43 starts the reproduction of the sound of a footstep before the predicted landing timing, it fades out the sound of the footstep being reproduced if landing is not actually detected at the predicted landing timing. This can make the user unaware of the sound of the footstep, and can prevent the provision of a feeling of strangeness such as hearing the sound of a footstep even though he or she has not landed. For example, in a case where the sound of stepping on fallen leaves is reproduced as the sound of a footstep, fade-out in the attack section can make the user feel it as only the sound of fallen leaves moving.

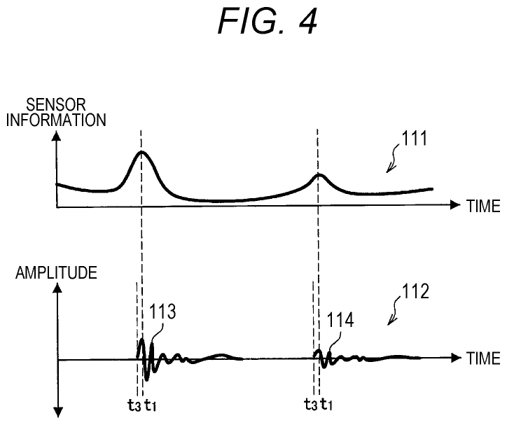

Specific examples of these reproduction controls will be described with reference to FIG. 4. FIG. 4 is a diagram for explaining an example of reproduction control according to the present embodiment. An upper graph 111 in FIG. 4 is a graph showing the temporal transition level or the sensor information, where the vertical axis is the sensor information (e.g., acceleration), and the horizontal axis is time. Actually, there are multiple-axis and multiple types of sensors, but one typical axis is shown here. A lower graph 112 in FIG. 4 is a graph showing the waveform of the sound of footsteps output at timings corresponding to the results of the prediction of landing timings, where the vertical axis is amplitude, and the horizontal axis is time. Assume that landing occurs at a timing t₁ when the sensor information peaks as shown in the graph 111. As shown in a waveform 113, the reproduction control unit 43 starts the reproduction of the sound of a footstep from a timing t₃ before the predicted landing timing t₁. On the other hand, if landing is not detected at the landing timing t₁, as shown in a waveform 114, the reproduction control unit 43 starts the reproduction of the sound of a footstep from the timing t₃ before the predicted landing timing t₁, while fading out the sound of the footstep from the timing t₁ forward.

### (3) Process Flow

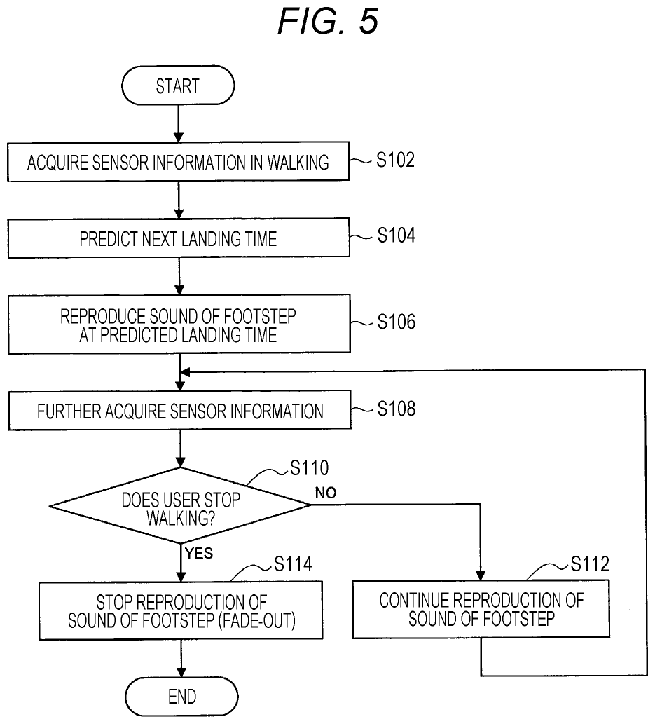

FIG. 5 is a flowchart showing an example of a flow of a content reproduction control process performed by the information processing apparatus according to the present embodiment. As shown in FIG. 5, first, the first sensor unit 10 acquires sensor information when the user is walking (step S102). Then, the prediction unit 42 predicts the next landing time on the basis of the sensor information (step S104). Next, the reproduction control unit 43 reproduces the sound of a footstep at the predicted landing time (step S106). Then, the first sensor unit 10 further acquires sensor information when the user is walking (step S108). Next, the detection unit 41 detects whether or not the user stops walking (step S110). For example, the detection unit 41 detects the landing of the user or whether or not the user is about to stop walking. Then, if it is detected that the user does not stop walking, such as when landing is actually detected or the continuation of walking is detected (step S110/NO), the reproduction control unit 43 continues the reproduction of the sound of a footstep (step S112). After that, the process returns to step S108. On the other hand, if it is detected that the user stops walking, such as when landing is not detected or it is detected that walking is about to be stopped (step S110/YES), the reproduction control unit 43 stops the reproduction of the sound of the footstep by fading out the sound of the footstep, for example (step S114).

### 3.2. Modifications

### (1) Reproduction Control According to Reliability

The reproduction control unit 43 may control the reproduction of content on the basis of the reliability of sensor information.

The reliability of sensor information can be defined as the degree of information on the user's traveling movement in the sensor information. In a case where the information processing apparatus 1 is implemented as headphones, cases where the reliability of sensor information is low include a case where the headphones are loosely fixed, and sensor information includes a high proportion of vibrations caused by displacement between the headphones and the user's head. In a case where the information processing apparatus 1 is implemented as a smartphone, cases where the reliability of sensor information is low include a case where the user is operating the smartphone by hand, and sensor information includes a high proportion of vibrations caused by the operation by hand.

The reliability of sensor information can be defined as the immediacy of the sensor information. For example, if sensing at regular intervals fails due to a high processing load, the reliability of sensor information is low.

The reliability of sensor information can be defined as the reliability of prediction by the prediction unit 42. For example, if it is difficult to predict the next movement, such as when the user repeats walking and stopping movement, the reliability of prediction is low. Further, if the degree of information on the user's traveling movement in sensor information is low, the reliability of prediction is low.

In the reproduction control based on the reliability of sensor information, the higher the reliability, the clearer content may be reproduced, and the lower the reliability, the obscurer content may be reproduced. For example, the reproduction control unit 43 may output a sound with a strong attack if the reliability is higher than a predetermined threshold value, and output a sound with a weak attack if the reliability is lower than the predetermined threshold value. A sound with a strong attack is a sound that has a short attack section, a high maximum volume at the end of the attack section, and/or a short section in which it attenuates from the maximum volume to a predetermined volume. An example of a sound with a strong attack is a sound in which a section of maximum amplitude (that is, maximum volume) appears within one second from the rise of the sound, and after one second and later, the amplitude of the sound attenuates to 20% or less of the maximum amplitude. A sound with a weak attack is a sound that has a long attack section, a low maximum volume at the end of the attack section, and/or a long section in which it attenuates from the maximum volume to a predetermined volume. Further, the reproduction control unit 43 may increase the volume if the reliability is higher than a predetermined threshold value, and reduce the volume if the reliability is lower than the predetermined threshold value. The higher the reliability, the clearer content is reproduced, so that the content can be clearly presented to the user. On the other hand, the lower the reliability, the obscurer content is reproduced, so that the provision of a feeling of strangeness to the user can be prevented even if prediction is wrong.

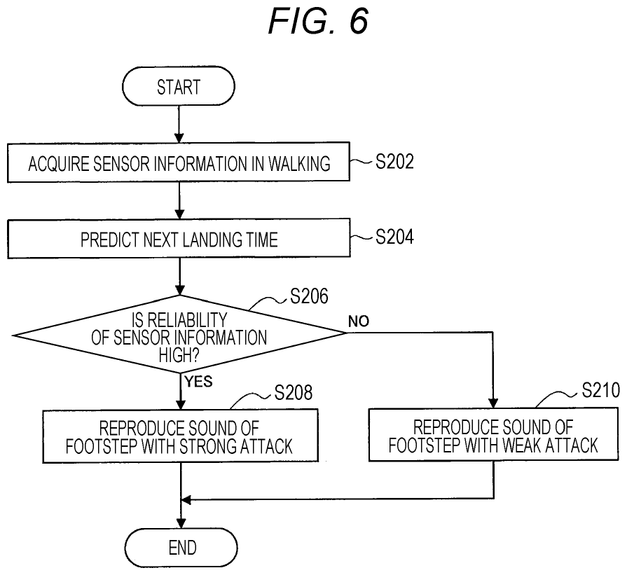

FIG. 6 is a flowchart showing an example of a flow of a reliability-based reproduction control process performed by the information processing apparatus 1 according to the present embodiment. As shown in FIG. 6, first, the first sensor unit 10 acquires sensor information when the user is walking (step S202). Then, the prediction unit 42 predicts the next landing time on the basis of the sensor information (step S204). Next, the reproduction control unit 43 determines whether or not the reliability of the sensor information is high (step S206). If it is determined that the reliability of the sensor information is high (step S206/YES), the reproduction control unit 43 reproduces the sound of a footstep with a strong attack (step S208). On the other hand, if it is determined that the reliability of the sensor information is low (step 3206/NO), the reproduction control unit 43 reproduces the sound of a footstep with a weak attack (step S210).

### (2) Reproduction Control Based on User Information or Character Information

The reproduction control unit 43 may control the reproduction of content on the basis of user information on a user or character information on a character corresponding to the user. Content reproduction control here includes selection of content to be reproduced, volume control, effect application, etc.

### State-Based Reproduction Control

The user information may include information indicating the state of the user such as the physical strength, the magnitude of a change in movement, the strength of movement, and the duration of movement of the user. The character information may include information indicating the state of the character such as the physical strength, the magnitude of a change in movement, the strength of movement, and the duration of movement of the character.

For example, the reproduction control unit 43 controls the reproduction of content on the basis of the magnitude (in other words, the intensity) of a change in the user's traveling movement indicated by sensor information. Specifically, if the user is running, the reproduction control unit 43 increases the volume of the sound of a footstep in proportion to the amplitude of acceleration, or selects the higher-volume sound of a footstep as an object to be reproduced. On the other hand, if the user is walking, the reproduction control unit 43 reduces the volume of the sound of a footstep, or reproduces the sound of a footstep once every few landing timings. Alternatively, the reproduction control unit 43 changes a sound source to be reproduced as the sound of a footstep, or changes parameters of an algorithm for generating the waveform of the sound of a footstep.

For example, the reproduction control unit 43 reproduces the powerful sound of a footstep if the character's physical strength in a game is high, and reproduces the sound of a footstep of a dragged or collapsed foot if the character is tired or attacked and damaged. Further, the reproduction control unit 43 reproduces the sound of a footstep of a weak image if the character becomes unable to fight. Of course, such control may be applied not only to the sound of footsteps but also to any sound when the body is moved. For example, the reproduction control unit 43 reproduces a powerful, sharp sound according to a hand's movement if the character's physical strength is high, and reproduces a dull sound if damage is inflicted.

### Reproduction Control Based on Attributes

The user information may include information indicating the attributes of the user, such as the user's age, sex, height, weight, and belongings. Information indicating the attributes of the user may be entered by the user, or may be recognized on the basis of the manner of walking or the like. The character information may include information indicating the attributes of the character, such as the character's age, sex, height, weight, equipment, and race. Information indicating the attributes of the character is acquired on the basis of setting information in a game or content such as VR content.

For example, in an AR experience, the reproduction control unit 43 outputs the sound of footsteps according to the user's age, shoes worn, and sex. Further, in a game experience, the reproduction control unit 43 outputs the mechanical sound of footsteps if the character is a realistic robot, outputs an electronic sound if the character is an animated robot, and outputs the soft sound of footsteps if the character is an animal.

Of course, in addition to the sound of footsteps, the reproduction control unit 43 may select a sound to be reproduced in synchronization with the user's waving movement, according to the attributes of the user or the character.

### Location-Based Reproduction Control

The user information may include information indicating the user's location, such as the user's geographical location information, information indicating a geographical area where the user is located, information indicating a room in a building where the user is located, and altitude. The character information may include information indicating the location of the character, such as information on the character's geographical location in a virtual space, information indicating a geographical area where the character is located, information indicating a room in a building where the character is located, and altitude.

For example, in an AR experience, the reproduction control unit 43 reproduces the sound of footsteps according to an area where the user is located For example, it reproduces the sound of water in an area on which a puddle is superimposed and displayed, and reproduces the sound of stepping on fallen leaves in an area on which the fallen leaves are superimposed and displayed. The same applies to the character.

### Configuration Example

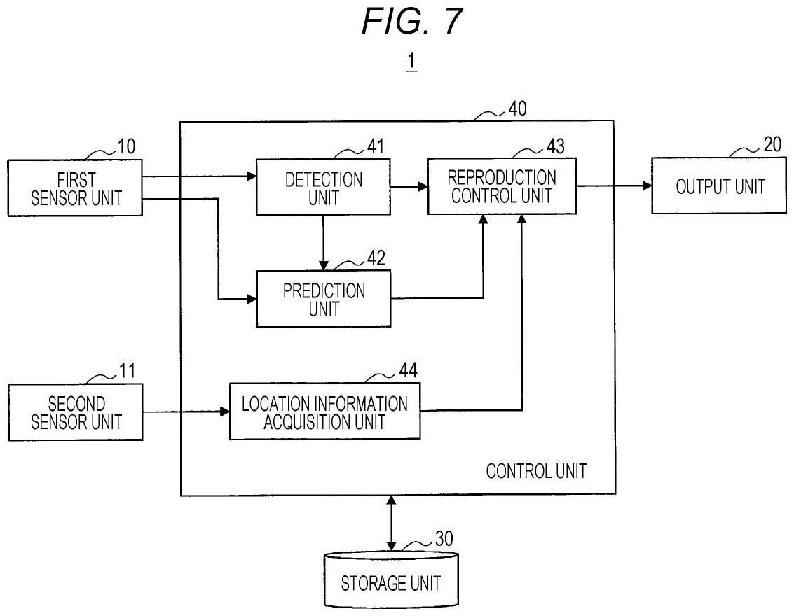

Here, a configuration for acquiring information indicating the user's location will be described with reference to FIG. 7. FIG. 7 is a block diagram showing another example of a logical configuration of the information processing apparatus 1 according to the present embodiment. The information processing apparatus 1 shown in FIG. 7 includes a second sensor unit 11 and a location information acquisition unit 44 in addition to the components shown in FIG. 3.

### Second Sensor Unit 11

The second sensor unit 11 has a function to sense information regarding the user's location. For example, the second sensor unit 11 may include an imaging device that captures a captured image around the user, a wireless communication device that transmits and receives signals to and from the surroundings, a Global Navigation Satellite System (GLASS) device, a geomagnetic sensor, an illuminance sensor, or the like. The second sensor unit 11 outputs sensor information obtained as a result of sensing to the control unit 40.

### Location Information Acquisition Unit 44

The location information acquisition unit 44 has a function to acquire information indicating the user's location on the basis of the sensor information obtained by the second sensor unit 11. For example, the location information acquisition unit 44 acquires information indicating the user's location on the basis of the result of simultaneous localization and mapping (SLAM) calculation based on a captured image around the user, a beacon received from the surroundings, GNSS information, or geomagnetic information The location information acquisition unit 44 may acquire information indicating whether it is indoors or outdoors on the basis of illuminance information. In addition, the location information may be manually entered by, for example, the user or an event operator.

### Reproduction Control Unit 43

The reproduction control unit 43 controls the reproduction of content further on the basis of the location information acquired by the location information acquisition unit 44. For example, the reproduction control unit 43 reproduces content stored in the storage unit 30 with reproduction parameters according to the location information acquired by the location information acquisition unit 44. For example, the reproduction control unit 43 reproduces the sound of sand if the user is located in an area on which a desert is superimposed, and reproduces the sound of water if the user is located in an area on which water is superimposed.

### (3) Control of Landing Detection Intervals

The detection unit 41 may control the intervals between landing detections, according to the state of the user. Specifically, while the detection unit 41 allows the detection of landing at short intervals if the user's traveling movement is large, it does not allow the detection of landing at short intervals if the user's movement is small.

Landing detection is typically performed on the basis of whether or not an evaluation value calculated on the basis of sensor information such as acceleration or angular velocity exceeds a first threshold value. Further, it is assumed that there is a certain amount of time between a landing and the next landing. Therefore, after a landing has been detected, the next landing is detected after a time exceeding a second threshold value has elapsed. Thus, after a landing has been detected, the detection unit 41 detects a landing when an evaluation value exceeds the first threshold value after a time exceeding the second threshold value has elapsed.

The detection unit 41 may dynamically set the first threshold value and the second threshold value on the basis of sensor information. For example, the detection unit 41 sets the first threshold value and the second threshold value for detecting the next landing, on the basis of the magnitude of sensor information at the time of the previous landing detection. When the user is walking slowly (for example, when acceleration is low), it is assumed that an impact at the time of landing is small, and the time interval between a landing and the next landing is long. Thus, if sensor information indicating that the user is walking slowly is acquired, the detection unit 41 sets the first threshold value small and the second threshold value large. On the other hand, when the user is running (for example, when acceleration is large), the detection unit 41 is assumed that an impact at the time of landing is large, and the time interval between a landing and the next landing is short. Thus, if sensor information indicating that the user is running is acquired, the detection unit 41 sets the first threshold value large and the second threshold value small.

### (4) Control of Sound Source Reproduction Parameters

The reproduction control unit 43 may control reproduction parameters of a sound source (that is, music) on the basis of the result of detection by the detection unit 41. Specifically, the reproduction control unit 43 sets the volume, the reproduction speed, the cutoff frequency of a lowpass filter, pan, and the like, on the basis of the result of detection of the magnitude of traveling movement. For example, if the user is walking slowly, the reproduction control unit 43 reproduces a slow-tempo sound source at a low volume. On the other hand, if the user is running, the reproduction control unit 43 reproduces a fast-tempo sound source at a high volume. This allows the user to get a feeling as if he or she is playing music even if he or she does not have a playing technique, and to enjoy a high musical experience. Further, more exciting music is reproduced when the user moves actively, so that running or walking is promoted.

Here, if the reproduction parameters are changed frequently, the user experience can deteriorate. For example, if the music reproduction speed is repeatedly changed in a short period of time, the beat of the music will be disturbed. Therefore, after changing a content reproduction parameter, the reproduction control unit 43 may restrain another change of the reproduction parameter until a predetermined time elapses. In other words, the reproduction control unit 43 that has changed a content reproduction parameter changes the reproduction parameter again after a predetermined time has elapsed. This reduces the frequency of changing the reproduction parameters, and thus can prevent the deterioration of the user experience.

Further, the reproduction control unit 43 may link the reproduction parameters to the largest value of sensor information if traveling movement changes significantly, and may use default reproduction parameters in other cases. Consequently, the default reproduction parameters are basically used, and the frequency of changing the reproduction parameters is reduced, so that the deterioration of The user experience can be prevented.

Further, the reproduction control unit 43 may select content reproduction parameters from discretized candidates. For example, the reproduction control unit 43 changes the reproduction speed to a reproduction speed that is 0.5 times, 1 time, 1.5 times, or 2 times a default reproduction speed, instead of changing it continuously. Consequently, the frequency of change is reduced as compared with the case where the reproduction parameters are continuously changed, so that the deterioration of the user experience can be prevented.

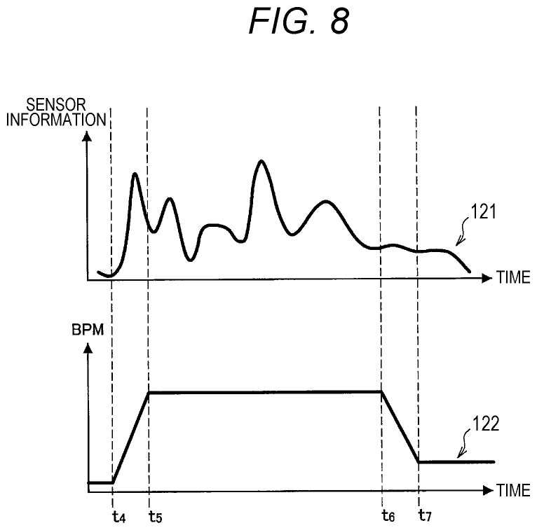

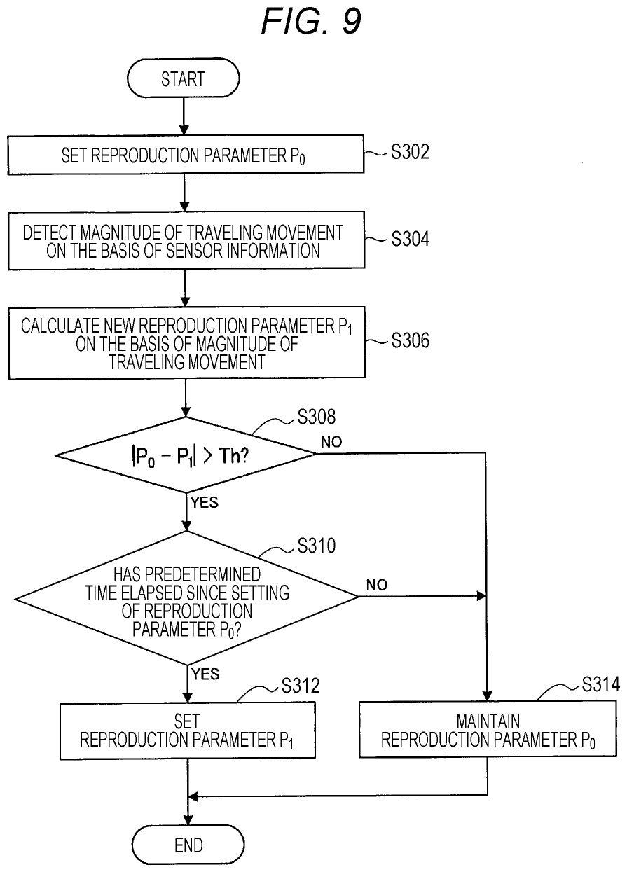

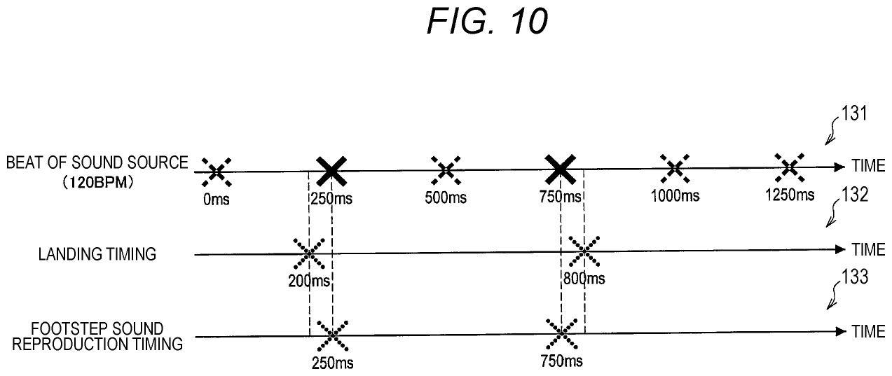

Hereinafter, a reproduction control process for preventing the deterioration of the user experience caused by the frequency of changing a reproduction parameter will be specifically described with reference to FIGS. 8 and 9.

FIG. 8 is a diagram for explaining an example of control of a sound source reproduction parameter according to the present embodiment. An upper graph 121 in FIG. 8 is a graph showing the temporal transition level of sensor information, where the vertical is the sensor information (e.g., acceleration), and the horizontal axis is time. A lower graph 122 in FIG. 8 is a graph showing the time-series transition of a reproduction parameter, where the vertical axis is beats per minute (BPM), and the horizontal axis is time. As shown in FIG. 8, the reproduction control unit 43 starts to increase the BPM from a time t₄ when the user starts traveling movement, and fixes the BPM at a time t₅ when the BPM corresponds to the magnitude of the traveling movement. Then, the reproduction control unit 43 maintains the same BPM until a time t₆ even after the traveling movement becomes slow, and then lowers the BPM until a time t₇.

FIG. 9 is a flowchart showing an example of a process of controlling a sound source reproduction parameter according to the present embodiment. First, the reproduction control unit 43 sets a reproduction parameter P₀ (step S302). Then, the detection unit 41 detects the magnitude of traveling movement on the basis of sensor information (step S304). Next, the reproduction control unit 43 calculates a new reproduction parameter P₁ on the basis of the detected magnitude of the traveling movement (step S306). Then, the reproduction control unit 43 determines whether or not the difference between the current parameter P₀ and the new parameter P₁ is larger than a threshold value Th (that is, whether or not |P₀−P₁|>Th holds) (step S308). If |P₀−P₁|<Th holds (step S308/YES), the reproduction control unit 43 determines whether or not a predetermined time has elapsed since the setting of the reproduction parameter P₀ (step S310). If it is determined that the predetermined time has elapsed since the setting of the reproduction parameter P₀ (step S310/YES), the reproduction control unit 43 sets the new reproduction parameter P₁ (step S312). On the other hand, if it is determined that |P₀−P₁|<Th does not hold (step S308/NO), or that the predetermined time has not elapsed since the setting of the reproduction parameter P₀ (step S310/NO), the reproduction control unit 43 maintains the reproduction parameter P₀ (step S314).

### (5) Reproduction Control According to Beat of Sound Source Being Reproduced

In a case where a sound source is reproduced, and the beat of the sound source being reproduced matches the timing of the predetermined state in traveling movement, the reproduction control unit 43 may control the reproduction of content (more accurately, content different from the sound source being reproduced). The timing of the predetermined state here may be a timing detected by the detection unit 41 or a timing predicted by the prediction unit 42. For example, the reproduction control unit 43 reproduces the sound of a footstep only when the beat of the sound source being reproduced matches a predicted landing timing. This allows the user to feel a sense of unity with music, improving the user experience.

Here, matching does not mean only exact matching, and is a concept that allows a deviation within a predetermined threshold value. In a case where the beat of a sound source being reproduced matches the timing of the predetermined state in traveling movement with a deviation within the predetermined threshold value, the reproduction control unit 43 reproduces content different from the sound source being reproduced at a timing corresponding to the beat of the sound source being reproduced. For example, in a case where the beat of a sound source being reproduced matches but does not exactly agree with the timing of landing, the reproduction control unit 43 reproduces the sound of a footstep at the timing of the beat of the sound source being reproduced, not the landing timing. In other words, the reproduction control unit 43 discretizes the reproduction timing of the sound of a footstep into the timing of the beat of the sound source being reproduced. This point will be specifically described with reference to FIG. 10.

FIG. 10 is a diagram for explaining an example of reproduction control of the sound of footsteps according to the beat of a sound source being reproduced, according to the present embodiment. An upper chart 131 in FIG. 10 is a chart showing the timings of beats of the sound source as “X” on a time axis. A middle chart 132 in FIG. 10 is a chart showing landing timings as “X” on a time axis. A lower chart 133 in FIG. 10 is a chart showing reproduction timings of the sound of footsteps as “X” on a time axis. As shown in the chart 131, at 120 BPM, a quarter note beat appears once every 500 milliseconds, and an eighth note beat appears once every 250 milliseconds. Letting a beat start timing be zero seconds, it is desirable that the sound of footsteps be reproduced at the numbers of seconds divisible by 250 milliseconds. Referring to the chart 132, landing timings predicted are 200 milliseconds and 800 milliseconds, which are not divisible by 250 milliseconds. Therefore, the reproduction control unit 43 reproduces the sound of a footstep corresponding to the landing timing of 200 milliseconds at 250 milliseconds, and reproduces the sound of a footstep corresponding to the landing timing of 800 milliseconds at 750 milliseconds. Consequently, even if the user's landing timing is out of sync with the beat of the sound source being reproduced, the sound of a footstep is reproduced at the timing of the beat, so that the user can feel a sense of unity with music.

### (6) Reproduction Control According to Bars of Sound Source Being Reproduced

In a case where a sound source is reproduced, and the beat of the sound source being reproduced matches the timing of the predetermined state in traveling movement, the reproduction control unit 43 may control the reproduction of the sound source being reproduced or another sound source at the timing of a change of bars of the sound source being reproduced. The timing of the predetermined state here may be a timing detected by the detection unit 41 or a timing predicted by the prediction unit 42. For example, if the beat of the sound source being reproduced matches the detected or predicted landing timing, the reproduction control unit 43 starts the reproduction of another sound source, stops the reproduction of the sound source being reproduced, or applies an effect to the sound source being reproduced, at the timing of a change of bars of the sound source being reproduced. Examples of applicable effects include an effect to obscure sound such as reverb, and an effect to clarify sound such as emphasis on the high-frequency range. Note that the start of reproduction may be regarded as raising the volume from zero, and the stop of reproduction may be regarded as making the volume zero.

For example, if traveling movement has been detected for a predetermined period, the reproduction control unit 43 may start the reproduction of another sound source at the timing of a change of bars. In this case, for example, as the user walks for a longer period, the number of sound sources reproduced gradually increases. On the other hand, if traveling movement has not been detected for a predetermined period, the reproduction control unit 43 may stop the reproduction of sound source being reproduced at the timing of a change of bars. In this case, for example, if the user stops walking, the number of sound sources reproduced gradually decreases. As the user traveling movement is continued more, the number of sound sources reproduced increases, and when the traveling movement is stopped, the number of sound sources reproduced decreases, so that running or walking can be promoted.

In a case where the reproduction of a new sound source is started at the timing of a change of bars of the sound source being reproduced, the newly reproduced sound source may be another sound source stored in the storage unit 30, or may be externally obtained by, for example, download.

In addition, a sound source reproduced may be a multitrack sound source. A multitrack sound source is a sound source including a plurality of tracks on which the sounds of vocals and individual musical instruments such as a drum are recorded. In a case where a multitrack sound source is reproduced, and the beat of the multitrack sound source being reproduced matches the timing of the predetermined state in traveling movement, the reproduction control unit 43 may control the reproduction of a plurality of tracks included in the multitrack sound source at the timing of a change of bars of a track being reproduced. For example, the reproduction control unit 43 stops the reproduction of a track being reproduced (that is, a track whose volume is not zero) or starts the reproduction of an unreproduced track (that is, a track whose volume is zero) at the timing of a change of bars of the multitrack sound source being reproduced. In addition, the reproduction control unit 43 may apply an effect at the timing of a change of bars of the multitrack sound source being reproduced.

For example, if traveling movement has been detected for a predetermined period, the reproduction control unit 43 may start the reproduction of an unreproduced track at the timing of a change of bars. In this case, for example, as the user walks for a longer period, the number of tracks reproduced gradually increases. On the other hand, if traveling movement has not been detected for a predetermined period, the reproduction control unit 43 may stop the reproduction of a track being reproduced at the timing of a change of bars. In this case, for example, if the user stops walking, the number of tracks reproduced gradually decreases. As the user continues traveling movement more, the number of tracks reproduced increases, and when the traveling movement is stopped, the number of tracks reproduced decreases, so that running or walking can be promoted.

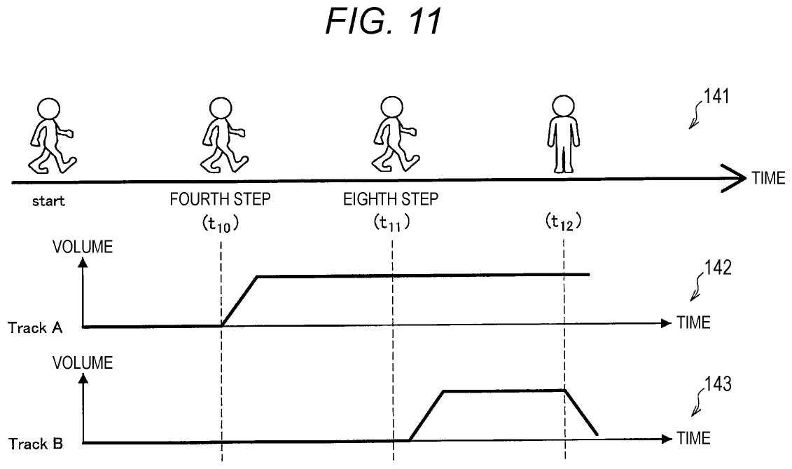

FIG. 11 is a diagram for explaining an example of reproduction control according to bars of a multitrack sound source being reproduced, according to the present embodiment. An upper chart 141 in FIG. 11 is a chart showing landing timings in a user traveling movement on a time axis. A middle graph 142 in FIG. 11 is a graph showing the volume of a track A included in the multitrack sound source, where the horizontal axis is time and the vertical axis is volume. A lower graph 143 in FIG. 11 is a graph showing the volume of a track B included in the multitrack sound source, where the vertical axis is volume and the horizontal axis is time. Here, assume that the number of steps shown in the chart 141 matches the beat of the multitrack sound source. If the multitrack sound source is in four-four time, four beats (that is, four steps) correspond to a bar. Thus, the reproduction control unit 43 starts the reproduction of the track A as shown in the graph 142 at the timing of the fourth step shown in the chart 141 (that is, a timing t₁₀ of a change of bars). Next, the reproduction control unit 43 starts the reproduction of the track B as shown in the graph 143 at the timing of the eighth step shown in the chart 141 (that is, a timing t₁₁ of a change of bars). Then, when the user stops walking, the reproduction control unit 43 stops the reproduction of the track B as shown in the graph 143 at a timing t₁₂ of a change of bars shown in the chart 141.

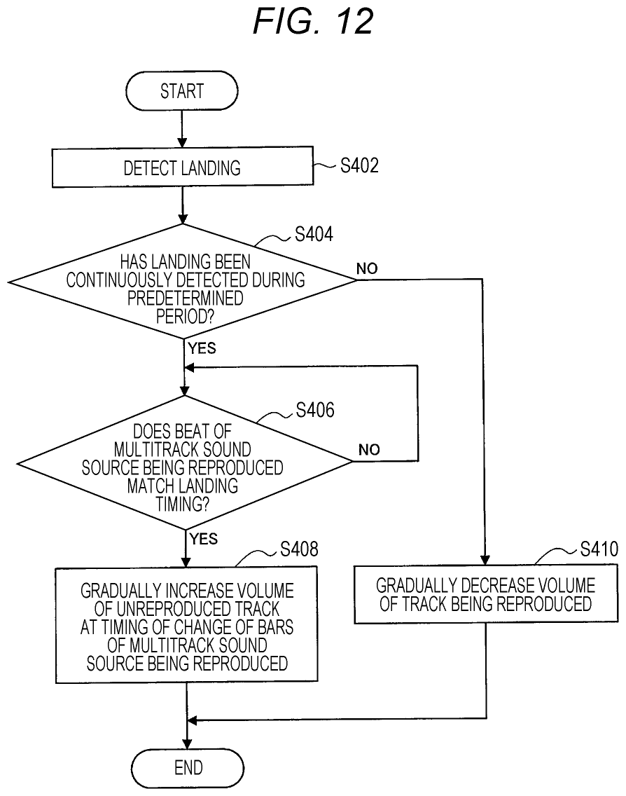

FIG. 12 is a flowchart showing an example of a flow of a reproduction control process according to bars of a multitrack sound source being reproduced, which is performed by the information processing apparatus 1 according to the present embodiment. As shown in FIG. 12, first, the detection unit 41 detects landing on the basis of sensor information (step S402). Next, the reproduction control unit 43 determines whether or not landing has been continuously detected during a predetermined period (step S404). If it is determined have been detected (step S404/YES), the reproduction control unit 43 determines whether or not the beat of the multitrack sound source being reproduced matches the landing timing (step S406). If it is determined to not match (step S406/NO), the process returns to step S406 again. If it is determined to match (step S406/YES), the reproduction control unit 43 gradually increases the volume of an unreproduced track at the timing of a change of bars of the multitrack sound source being reproduced (step S408). On the other hand, if it is determined that landing has not been continuously detected during the predetermined period (step S404/NO), the reproduction control unit 43 gradually lowers the volume of the track being reproduced (step S410).

### 4. HARDWARE CONFIGURATION EXAMPLE

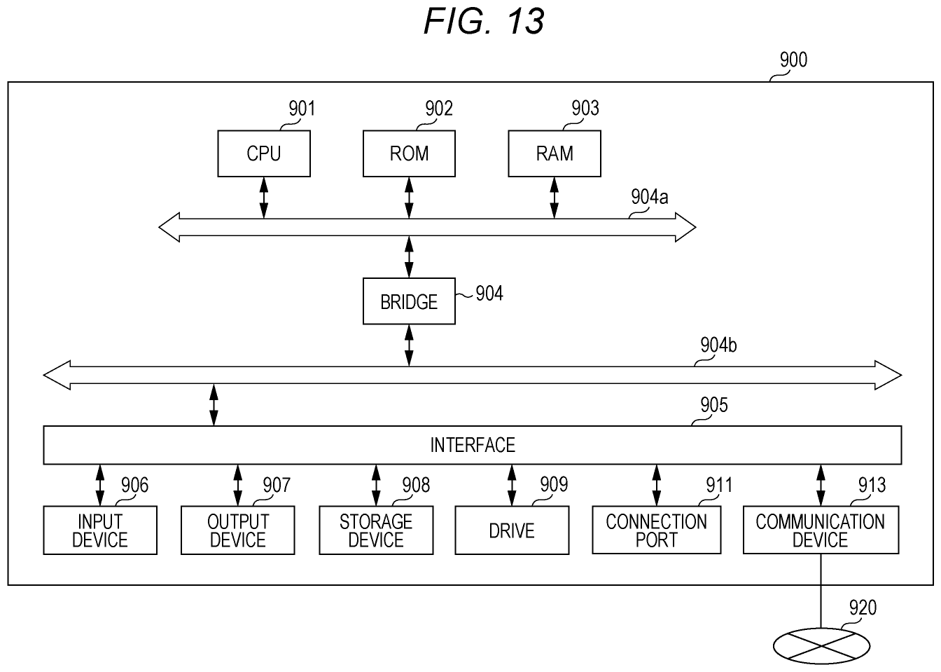

Finally, with reference to FIG. 13, a hardware configuration of an information processing apparatus according to the present embodiment will be described. FIG. 13 is a block diagram showing an example of a hardware configuration of an information processing apparatus according to the present embodiment. Note that an information processing apparatus 900 shown in FIG. 13 can implement, for example, the information processing apparatus 1 shown in FIGS. 3 and 7. Information processing by the information processing apparatus 1 according to the present embodiment is implemented by cooperation between software and hardware described below.

As shown in FIG. 13, the information processing apparatus 900 includes a central processing unit (CPU) 901, a read-only memory (ROM) 902, a random-access memory (RAM) 903, and a host bus 904a. Further, the information processing apparatus 900 includes a bridge 904, an external bus 904b, an interface 905, an input device 906, an output device 907, a storage device 908, a drive 909, a connection port 911, and a communication device 913. The information processing apparatus 900 may include a processing circuit such as an electric circuit, a DSP, or an ASIC in place of or together with the CPU 901.

The CPU 901 functions as an arithmetic processing unit and a controller, and controls all operations in the information processing apparatus 900 according to various programs. Further, the CPU 901 may be a microprocessor. The ROM 902 stores programs, operation parameters, etc. used by the CPU 901. The RAM 903 temporarily stores a program used in execution of the CPU 901, parameters that change as appropriate in the execution, etc. The CPU 901 can form, for example, the control unit 40 shown in FIGS. 3 and 7.

The CPU 901, the ROM 902, and the RAM 903 are connected to each other by the host bus 904a including a CPU bus etc. The host bus 904a is connected to the external bus 904b such as a Peripheral Component Interconnect Interface (PCI) bus via the bridge 904. Note that the host bus 904a, the bridge 904, and the external bus 904b do not necessarily need to be configured separately, and these functions may be implemented in one bus.

The input device 906 is implemented by a device into which information is entered by the user, such as a mouse, a keyboard, a touch panel, a button, a microphone, a switch, and a lever. Further, the input device 906 may be, for example, a remote control device using infrared rays or other radio waves, or an eternally connected device such as a mobile phone or a PDA that supports the operation of the information processing apparatus 900. Moreover, the input device 906 may include, for example, an input control circuit that generates an input signal on the basis of information entered by the user using the above input means, and outputs it to the CPU 901. By operating the input device 906, the user of the information processing apparatus 900 can enter various data into and instruct a processing operation to the information processing apparatus 900.

In addition, the input device 906 may be formed by a device that detects information associated with the user. For example, the input device 906 may include various sensors such as an image sensor (e.g., a camera), a depth sensor (e.g., a stereo camera), an acceleration sensor, a gyroscope sensor, a geomagnetic sensor, an optical sensor, a sound sensor, a distance measuring sensor, and a force sensor. Further, the input device 906 may acquire information regarding the state of the information processing apparatus 900 itself, such as the position and travel speed of the information processing apparatus 900, and information regarding the surrounding environment of the information processing apparatus 900, such as brightness and noise around the information processing apparatus 900. In addition, the input device 906 may include a Global Navigation Satellite System (GNSS) module that receives a GNSS signal from a GNSS satellite (e.g., a Global Positioning System (GPS) signal from a GPS satellite) and measures location information including the latitude, longitude, and altitude of the apparatus. Further, for the location information, the input device 906 may detect the location by Wi-Fi (registered trademark), transmission and reception with a mobile phone, a PHS, a smartphone, or the like, short-range communication, or the like. The input device 906 can form, for example, the first sensor unit 10 and the second sensor unit 11 shown in FIGS. 3 and 7.

The output device 907 is formed by a device capable of visually or aurally notifying the user of acquired information. Examples of such a device include display devices such as a CRT display device, a liquid crystal display device, a plasma display device, an EL display device, a laser projector, an LED projector, and a lamp, audio output devices such as a speaker and headphones, and a printer device. The output device 907 outputs, for example, results obtained by various types of processing performed by the information processing apparatus 900. Specifically, the display device visually displays results obtained by various types of processing performed by the information processing apparatus 900, in various forms such as text, an image, a table, and a graph. On the other hand, the audio output device converts an audio signal including reproduced audio data, acoustic data, or the like into an analog signal, and outputs it aurally. The output device 907 can form, for example, the output unit 20 shown in FIGS. 3 and 7.

The storage device 908 is a data storage device formed as an example of a storage unit of the information processing apparatus 900. The storage device 908 is implemented by, for example, a magnetic storage device such as an HDD, a semiconductor storage device, an optical storage device, a magneto-optical storage device, or the like. The storage device 908 may include a storage medium, a recording device that records data on the storage medium, a reading device that reads data from the storage medium, a deletion device that deletes data recorded on the storage medium, etc. The storage device 908 stores programs executed by the CPU 901, various data, various data acquired from the outside, etc. The storage device 908 can form, for example, the storage unit 30 shown in FIGS. 3 and 7.

The drive 909 is a storage medium reader/writer, and is built in or externally attached to the information processing apparatus 900. The drive 909 reads information recorded on a removable storage medium inserted therein, such as a magnetic disk, an optical disk, a magneto-optical disk, or a semiconductor memory, and outputs it to the RAM 903. Furthermore, the drive 909 can write information to the removable storage medium.

The connection port 911 is an interface connected to an external device, and is a connection port for an external device capable of transmitting data by, for example, Universal Serial Bus (USB).

The communication device 913 is, for example, a communication interface formed by a communication device for connection to the network 920, or the like. The communication device 913 is, for example, a communication card for a wired or wireless local-area network (LAN), Long Term Evolution (LTE), Bluetooth (registered trademark), or Wireless USB (WUSB), or the like. Further, the communication device 913 may be a router for optical communication, a router for Asymmetric Digital Subscriber Line (ADSL), a modem for various types of communications, or the like. The communication device 913 can transmit and receive signals etc. to and from for example, the Internet and other communication devices in accordance with a predetermined protocol such as TCP/IP.

Note that the network 920 is a wired or wireless transmission path for information transmitted from an apparatus connected to the network 920. For example, the network 920 may include public networks such as the Internet, a telephone network, and a satellite communication network, various local-area networks (LANs) including Ethernet (registered trademark), a wide area network (WAN), etc. Further, the network 920 may include a private network such as an Internet Protocol-Virtual Private Network (IP-VPN).

The above has shown an example of a hardware configuration capable of implementing the functions of the information processing apparatus 900 according to the present embodiment. Each of the above components may be implemented using a general-purpose member, or may be implemented by hardware specialized for the function of the component. Thus, it is possible to appropriately change a hardware configuration to be used according to the technical level at each time when the present embodiment is implemented.

Note that it is possible to create a computer program for implementing each function of the information processing apparatus 900 according to the present embodiment as described above, and install it on a PC or the like. Furthermore, it is possible to provide a computer-readable recording medium in which such a computer program is stored. The recording medium is, for example, a magnetic disk, an optical disk, a magneto-optical disk, a flash memory, or the like. Further, the above computer program may be delivered via a network, for example, without using a recording medium.

### 5. SUMMARY

As above, one embodiment of the present disclosure has been described in detail with reference to FIGS. 1 to 13. As described above, the information processing apparatus 1 according to the present embodiment controls the reproduction of content on the basis of the result of prediction of the timing of a predetermined state in a user's traveling movement, which is predicted on the basis of sensor information regarding the traveling movement. Since the reproduction control of the content according to the prediction result can be started before the predetermined state in the traveling movement is actually detected, the content can be provided in real time according to the user's body movement. For example, the information processing apparatus 1 starts footstep sound reproduction processing earlier than a landing timing, on the basis of the result of prediction of the landing timing in the user's walking movement. This can prevent occurrence of a time lag between the actual landing timing and the footstep sound reproduction timing.

Although a preferred embodiment of the present disclosure has been described in detail above with reference to the accompanying drawings, the technical scope of the present disclosure is not limited to the example. It is obvious that a person having ordinary skill in the technical field of the present disclosure can arrive at various alterations or modifications within the scope of the technical ideas described in the claims. These are, of course, considered to belong to the technical scope of the present disclosure.

For example, in the above embodiment, the information processing apparatus 1 includes the first sensor unit 10, the second sensor unit 11, the output unit 20, the storage unit 30, and the control unit 40, but the present technology is not limited to this example. For example, at least part of the components of the first sensor unit 10, the second sensor unit 11, the output unit 20, the storage unit 30, and the control unit 40 may be implemented as a device separate from the other components. For example, a smartphone may include the first sensor unit 10, the second sensor unit 11, the storage unit 30, and the control unit 40, and be connected to headphones including the output unit 20. Furthermore, a smartphone may include the storage unit 30 and the control unit 40, and be connected to a wearable device worn on a limb, which includes the first sensor unit 10 and the second sensor unit 11, and earphones including the output unit 20. Moreover, the storage unit 30 and the control unit 40 may be included in a server on the cloud, and connected to a terminal device including the first sensor unit 10, the second sensor unit 11, the storage unit 30, and the control unit 40, via a network.

Further, there can be various use cases of the present technology other than the use cases described in the above embodiment. For example, the present technology may be used. for medical purposes. For example, the information processing apparatus 1 feeds back a landing timing by a sound or by an image to a patient undergoing walking rehabilitation. This makes it easier for the patient to grasp a walking rhythm. Further, the information processing apparatus 1 may present the next target step position by a sound or an image. Furthermore, the information processing apparatus 1 may record a daily walking log and provide the patient with the degree of improvement.

Further, the effects described in the present description are merely illustrative or exemplary and are not limiting. That is, the technology according to the present disclosure can achieve other effects that are obvious to those skilled in the art from the description of the present description, in addition to the above effects or in place of the above effects.

Note that the following configurations also belong to the technical scope of the present disclosure.

(1)

An information processing apparatus including a reproduction control unit that controls reproduction of content on the basis of a result of prediction of a timing of a predetermined state in traveling movement of a user, which is predicted on the basis of sensor information regarding the traveling movement.

(2)

The information processing apparatus according to (1) above, in which the timing of the predetermined state is predicted on the basis of time-series transition of a time interval between timings of the predetermined state that have been detected on the basis of the sensor information.

(3)

The information processing apparatus according to (1) or (2) above, in which the timing of the predetermined state is predicted on the basis of time-series transition of the sensor information.

(4)

The information processing apparatus according to any one of (1) to (3) above, in which the timing of the predetermined state is predicted on the basis of a result of prediction of time-series transition of the sensor information or a result of prediction of time-series transition of a result of calculation based on the sensor information.

(5)

The information processing apparatus according to any one of (1) to (4) above, in which

the reproduction control unit

reproduces the content at the predicted timing of the predetermined state, and

controls the reproduction of the content when it is not detected from the sensor information that the predetermined state actually occurs at the predicted timing of the predetermined state.

(6)

The information processing apparatus according to (5) above, in which the reproduction control unit stops the reproduction of the content, lowers volume, or applies a predetermined effect to the content.

(7)

The information processing apparatus according to (6) above, in which the predetermined effect is blurring or fade-out.

(8)

The information processing apparatus according to any one of (1) to (7) above, in which the reproduction control unit controls the reproduction of the content on the basis of reliability of the sensor information.

(9)

The information processing apparatus according to (8) above, in which the reproduction control unit outputs a sound with a strong attack when the reliability is higher than a predetermined threshold value, and outputs a sound with a weak attack when the reliability is lower than the predetermined threshold value.

(10)

The information processing apparatus according to any one of (1) to (9) above, in which the timing of the predetermined state is a timing of landing in walking movement or running movement, or a timing of reaching a highest point in lumping movement.

(11)

The information processing apparatus according to any one of (1) to (10) above, in which the reproduction control unit controls the reproduction of the content, on the basis of user information on the user or character information on a character corresponding to the user.

(12)

The information processing apparatus according to (11) above, in which the user information includes at least one of the user's attribute, state, or location.

(13)

The information processing apparatus according to (12) above, in which

the content includes sound and,

the user's state includes magnitude of a change in the traveling movement of the user indicated by the sensor information.

(14)

The information processing apparatus according to (11) above, in which the character information includes at least one of the character's attribute, state, or location.

(15)

The information processing apparatus according to any one of (1) to (14) above, in which the reproduction control unit that has changed a reproduction parameter of the content restrains another change of the reproduction parameter until a predetermined time elapses.

(16)

The information processing apparatus according to any one of (1) to (15) above, in which the reproduction control unit reproduces a sound source, and controls the reproduction of the content when a beat of the sound source being reproduced matches the predicted timing of the predetermined state.

(17)

The information processing apparatus according to any one of (1) to (16) above, in which the reproduction control unit reproduces a sound source, and controls reproduction of the sound source being reproduced or another sound source at a timing of a change of bars of the sound source being reproduced when a beat of the sound source being reproduced matches the timing of the predetermined state.

(18)

The information processing apparatus according to (17) above, in which the reproduction control unit reproduces a multitrack sound source, and controls reproduction of a plurality of tracks included in the multitrack sound source at a timing of a change of bars of the multitrack sound source being reproduced when a beat of the multitrack sound source being reproduced matches the timing of the predetermined state.

(19)

An information processing method performed by a processor, including controlling reproduction of content on the basis of a result of prediction of a timing of a predetermined state in traveling movement of a user, which is predicted on the basis of sensor information regarding the traveling movement.

(20)

A recording medium in which a program is recorded to cause a computer to function as

a reproduction control unit that controls reproduction of content on the basis of a result of prediction of a timing of a predetermined state in traveling movement of a user, which is predicted on the basis of sensor information regarding the traveling movement.

### REFERENCE SIGNS LIST

1 Information processing apparatus
10 First sensor unit
11 Second sensor unit
20 Output unit
30 Storage unit
40 Control unit
41 Detection unit
42 Prediction unit
43 Reproduction control unit
44 Location information acquisition unit

1. An information processing apparatus comprising a reproduction control unit that controls reproduction of content on a basis of a result of prediction of a timing of a predetermined state in traveling movement of a user, which is predicted on a basis of sensor information regarding the traveling movement.

2. The information processing apparatus according to claim 1, wherein the timing of the predetermined state is predicted on a basis of time-series transition of a time interval between timings of the predetermined state that have been detected on the basis of the sensor information.

3. The information processing apparatus according to claim 1, wherein the timing of the predetermined state is predicted on a basis of time-series transition of the sensor information.

4. The information processing apparatus according to claim 1, wherein the timing of the predetermined state is predicted on a basis of a result of prediction of time-series transition of the sensor information or a result of prediction of time-series transition of a result of calculation based on the sensor information.

5. The information processing apparatus according to claim 1, wherein
the reproduction control unit
reproduces the content at the predicted timing of the predetermined state, and
controls the reproduction of the content when it is not detected from the sensor information that the predetermined state actually occurs at the predicted timing of the predetermined state.

6. The information processing apparatus according to claim 5, wherein the reproduction control unit stops the reproduction of the content, lowers volume, or applies a predetermined effect to the content.

7. The information processing apparatus according to claim 6, wherein the predetermined effect is blurring or fade-out.

8. The information processing apparatus according to claim 1, wherein the reproduction control unit controls the reproduction of the content on a basis of reliability of the sensor information.

9. The information processing apparatus according to claim 8, wherein the reproduction control unit outputs a sound with a strong attack when the reliability is higher than a predetermined threshold value, and outputs a sound with a weak attack when the reliability is lower than the predetermined threshold value.

10. The information processing apparatus according to claim 1, wherein the timing of the predetermined state is a timing of landing in walking movement or running movement, or a timing of reaching a highest point in lumping movement.

11. The information processing apparatus according to claim 1, wherein the reproduction control unit controls the reproduction of the content, on a basis of user information on the user or character information on a character corresponding to the user.

12. The information processing apparatus according to claim 11, wherein the user information includes at least one of the user's attribute, state, or location.

13. The information processing apparatus according to claim 12, wherein
the content includes sound and,
the user's state includes magnitude of a change in the traveling movement of the user indicated by the sensor information.

14. The information processing apparatus according to claim 11, wherein the character information includes at least one of the character's attribute, state, or location.

15. The information processing apparatus according to claim 1, wherein the reproduction control unit that has changed a reproduction parameter of the content restrains another change of the reproduction parameter until a predetermined time elapses.

16. The information processing apparatus according to claim 1, wherein the reproduction control unit reproduces a sound source, and controls the reproduction of the content when a beat of the sound source being reproduced matches the predicted timing of the predetermined state.

17. The information processing apparatus according to claim 1, wherein the reproduction control unit reproduces a sound source, and controls reproduction of the sound source being reproduced or another sound source at a timing of a change of bars of the sound source being reproduced when a beat of the sound source being reproduced matches the timing of the predetermined state.

18. The information processing apparatus according to claim 17, wherein the reproduction control unit reproduces a multitrack sound source, and controls reproduction of a plurality of tracks included in the multitrack sound source at a timing of a change of bars of the multitrack sound source being reproduced when a beat of the multitrack sound source being reproduced matches the timing of the predetermined state.

19. An information processing method performed by a processor, comprising controlling reproduction of content on a basis of a result of prediction of a timing of a predetermined state in traveling movement of a user, which is predicted on a basis of sensor information regarding the traveling movement.

20. A recording medium in which a program is recorded to cause a computer to function as
a reproduction control unit that controls reproduction of content on a basis of a result of prediction of a timing of a predetermined state in traveling movement of a user, which is predicted on a basis of sensor information regarding the traveling movement.
